(19) United States
(12) Patent Application Publication
(10) Pub. No.: US 2012/0015093 A1
(43) Pub. Date: Jan. 19, 2012

(54) Whole seed processing and controlled viscosity products

(76) Inventors: John M. Finney, Eden Prairie, MN (US); Christopher J. Rueb, St. Paul, MN (US); William A. Hendrickson, Stillwater, MN (US); Daniel R. Roesler, Stillwater, MN (US); Robert G. Bowman, Woodbury, MN (US); David A. Canfield, St. Paul Park, MN (US)

(21) Appl. No.: 12/804,230

(22) Filed: Jul. 16, 2010

(51) Int. Cl. A23L 1/0526; B02C 23/18; B02C 9/04; B02C 11/00; A23L 2/38; A23L 1/40

(52) U.S. Cl. 426/589; 426/507; 426/629; 426/598; 241/12; 241/9; 241/23; 241/24.26

(57) ABSTRACT

A method provides a milled whole seed product from a whole seed having at least 0.01% by total weight of oil therein. The whole seed is added to an aqueous carrier which is physically milled at a shear rate of at least 3,000 r.p.m. The shearing is continued until at least 50% by weight of seed solids will pass through a square mesh screen having 1.2 mm screen hole dimensions. The solids in aqueous carrier is collected as a suspension or dispersion in the aqueous carrier. The collected seed solids in aqueous carrier are dried to form a free-flowing powder. The free-flowing powder is rehydrated with a second aqueous medium to form a non-mucilaginous suspension or dispersion.

### BACKGROUND OF THE INVENTION

1. Field of the Invention

The present invention relates to the field of physical seed processing, the manufacture of whole seed products, the manufacture of whole seed dried powder products that can be reconstituted to a liquid composition with controlled viscosity.

2. Background of the Art

Seeds have been physically processed for centuries, often by the use of physical labor. There are even biblical references to threshing, which is the physical pounding of wheat by hand tools to separate the wheat grain from the chaff. Many of the physical processing techniques used in modern times are refinements of that type of physical activity using more sophisticated tools than clubs for the impact action on whole seeds and grains. Chemical treatments and extraction processes have also been added to effect specific results, such as oil extraction, protein extraction, dye extraction, and removal of other harmful or desired materials to form desired agricultural products.

Among some processing techniques for seeds and grains are at least the following. U.S. Pat. No. 7,678,403 (Mitchell) discloses a method comprising selection of unbroken whole grain rice that are first washed, or whole grain corn that is first reduced in size, and then making an aqueous slurry that is subsequently wet milled to release all the protein, fat, fiber, and starch components normally held in the structure of the grain. The resulting slurry can be reacted with heat to gelatinize the starch and the subsequent product dried. Also, the heated slurry containing the liberated components can be treated to enzymatic hydrolysis via the process of liquefaction and optionally saccharification, producing whole grain rice milk products having diverse carbohydrate compositions. The whole grain milk products are characterized by a nutritional composition containing substantially all the nutritional components of the whole grain, being an opaque whole milk colloid, having smooth texture versus pulpiness, lacking in all bitterness normally associated with whole grain products, and having a variety of sweetness levels from non-sweet to very sweet.

U.S. Pat. No. 6,737,099 (Guraya) discloses slurries of amylaceous flour from milled seed of cereals, beans, and legumes containing dispersed particles of starch-protein agglomerates are subjected to high pressure processing to obtain deagglomerated starch granules and protein. Further treatment of the deagglomerated product leads to the recovery of a novel protein-coated starch product or to the isolation of starch and protein of high purity and quality. The method improves the recovery of starch during classification/separation from protein and is therefore economical. Starch reduced to individual granules, with low starch damage, low protein content, and with improved pasting characteristics, can be produced using this deagglomerization method. The protein obtained by the process has better solubility and is therefore suitable for beverage applications.

U.S. Pat. No. 4,416,701 (Huster) discloses a method for the production of starch from grain or ground grain products by the wet process comprises a brief steeping of the raw material during which the morphological structures are not broken down by chemical or microbiological processes, and of a comminuting of the steeped raw material in a high-pressure apparatus equipped with a splitter head. In this high-pressure apparatus, the steeped raw material is subjected to a pressure of at least 10 bar, fragmented under the action of high shear forces, and exposed to the atmosphere, thus causing the necessary structural breakdown between the starch grains and the protein. For shelled corn after the addition of process water, the shelled corn is fed to a heated pressure steeping apparatus. After a maximum of three hours at a pressure of 10 to 15 bar, the necessary moisture absorption is achieved. Excess water is fed to an evaporator. A pressure reducing apparatus at the output of the steeping apparatus produces a preliminary fragmentation of the corn grains. The germs can be separated from the corn mash by means of a degerminator. In a high-pressure apparatus, equipped with a splitter head, the breakdown of the morphological structure between the starch grains and the protein matrix is performed at a pressure of approximately 100 bar, together with a fine fragmentation of the raw material.

U.S. Pat. No. 6,936,110 (Van Thorre) discloses a method for extracting protein, oil and starch from grain. The method includes: Providing kernels or seeds comprising a germ and pericarp comprising protein, oil, and starch; Steeping the kernels or seeds in a steeping reactor for a time effective to soften the kernels and seeds; milling the steeped corn kernels to separate the germ from the starch/pericarp forming a germ stream and a starch/pericarp stream; Subjecting the germ to rapid pressurization/depressurization in order to extract oil and protein from the germ; and separating the starch from the pericarp.

U.S. Pat. No. 6,827,965 (Fitzpatrick) discloses food products containing whole Chia seeds or a gluten-free agglutinant derived therefrom are made by mixing a food material with water, adding whole Chia seeds or an agglutinant derived therefrom in an agglutinating amount, and reducing the water activity of the mixture. Other ingredients such as honey, syrups, and sprouted grains can also be mixed with the Chia seeds. The gluten free varieties are of especial value for those individuals who are allergic to the gluten in wheat and other grains.

U.S. Pat. No. 5,009,916 (Colliopoulos) discloses a composition for making and using psyllium high fiber food products useful as a dietary aid. In particular, the compositions contain a dry blend of high fiber food product base which may be incorporated into a psyllium fiber drink mix or extended psyllium fiber bar or puff. A method of making an expanded high fiber bar or puff comprising making a mixture comprising psyllium mucilloid, 0 to 69 weight percent of an expander and a total dietary fiber from a grain source of from about 0 to 93 weight percent wherein the psyllium may be a part of the dietary fiber, blending the mixture until substantially homogeneous and then extruding with water at a temperature of from about 130 to 200° C. such that the final product has a psyllium content of between 5 to 99 weight percent, and wherein the dietary fiber comprises psyllium and one or more dietary fibers from a grain source selected from the group consisting of corn bran, wheat bran, and rice bran.

U.S. Pat. No. 6,634,576 (Verhoff) discloses a process for milling a solid substrate in the milling chamber of a dispersion or media mill in the presence of a two or more compositions of milling media bodies is disclosed wherein all milling media bodies contribute to the grinding of the solid substrate and wherein at least one composition of media bodies provides fragments of milling media bodies that are retained with the milled solid substrate particles in the form of a synergetic commixture produced in the milling process. More specifically, a process is disclosed for preparing a synergetic commixture comprising small particles of a solid substrate and small particulates of a first material of a desired size comprising the steps of (a) providing to the milling chamber of a media mill a contents comprising a pre-mix of a solid substrate, a fluid carrier, a plurality of milling bodies of a first material having a fracture toughness K_{c1}, and a plurality of milling bodies of a second material having a fracture toughness K_{c2}; (b) operating the media mill to grind the solid substrate and degrade at least a portion of the milling bodies of first material to produce a dispersion in the fluid carrier comprising a synergetic commixture of small particulates of the first material and small particles of the solid substrate having a desired size equal to or less than a size Sp; (c) separating the dispersion from any milling bodies and solid substrate particles having a size larger than Sₚ; and (d) optionally removing the fluid carrier from the dispersion to form a synergetic commixture free of fluid and comprising the particles and the small particulates, wherein K_{c2} is greater than K_{c1}.

Published U.S. Patent Document No. 20020003179 (Verhoff) discloses a process for preparing a dispersion of solid particles of a milled substrate in a fluid carrier comprising the steps of (a) providing a plurality of large size milling media to the milling chamber of a media mill and forming a depth filter therefrom on an exit screen or separator in the milling chamber; (b) adding to said milling chamber a plurality of small size milling media optionally containing additional large size milling media, a conglomerate of a solid substance comprising a substrate to be milled and optionally one or more than one surface active substance, and a fluid carrier; (c) milling said conglomerate in said milling chamber to produce very small milled substrate product particles; and (d) separating said milled substrate particles suspended in said fluid carrier from the media through said depth filter; wherein the exit screen comprises openings of size S₀; the large size media have a size distribution S₁ of which all are larger than S₀; the small size media have a size distribution S₂ which are smaller than S₀; the very small milled substrate particles have a size distribution S₃ and are smaller than all of the small media; and the large size media and the small size media are essentially retained in the milling chamber.

U.S. Pat. No. 4,060,203 (Edwards) discloses a process for extracting protein from lupins and other low fat seeds having an improvement comprising saturating the seeds with water and wet milling them prior to extracting the protein thereby avoiding undue denaturation of the protein

Improved milling and composition products are still needed in the field. Each and every reference cited herein is incorporated by reference in their entirety for their disclosures.

### SUMMARY OF THE INVENTION

A dry, deliverable, reconstitutable powder is formed from milled whole seed. Seed containing oils, and especially omega-3 oils are particularly desirable in providing the powder and additional bye-products. The reconstituable powder can be a free-flowing dry powder and then can be rehydrated and redispensed, and the viscosity of the reconstituted powder can be facilely controlled. Preferred seed is Chia.

The whole seed is wet milled under defined shear conditions and then dried. The reconstituted powder may be non-mucilaginous under preferred manufacturing conditions.

### BRIEF DESCRIPTION OF THE FIGURES

FIG. 1 shows a flow diagram of a process according to the present technology.

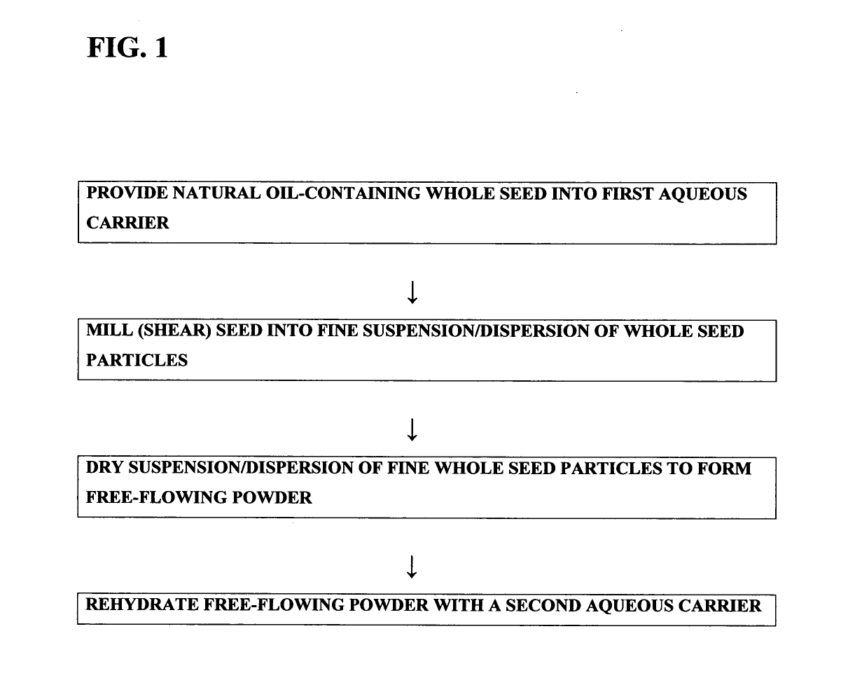

### DETAILED DESCRIPTION OF THE INVENTION

Whole seed is added to an aqueous medium, preferably water, and preferably deionized water to form a whole seed initial mass. The whole seed initial mass is then milled wet under high shear conditions to produce a milled aqueous suspension having a range of properties in the suspension depending upon shear conditions. The range of viscosity properties available in the whole seed initial mass through the most highly sheared suspension are somewhat scholastically represented as within a range that may be defined as:

1) Low viscosity liquid, but thicker than water, such as with whole milk.

2) Pours out of a spoon as a clean ribbon, such as cake batter.

3) Thick liquid such as with ketchup.

4) Self-adhering clumps as with oatmeal or Cream of Wheat cereal.

5) A single clump that pours off spoon, as with soft yogurt.

6) Too thick to pour off spoon.

It has been found in the practice of the present technology that the viscosity of the sheared dispersion may be varied within a desirable range, the dispersion dried to flowable particles and then the flowable particles rehydrated to a non-mucilaginous, or non-clumping nearly identical viscosity as the dispersion. The viscosity and size distribution of resulting whole seed particles are dependent upon shear strength and duration, which are in control of the operator. The relationship and the ability to control both the slurry (high sheared suspension) properties and the ability of a dried product to be reconstituted to a non-mucilaginous state has never been found before, and the processes and the products are novel.

Any physical shearing system capable of providing controlled and high shear conditions may be used in the practice of this technology. Blade mixers, sonic or ultrasonic mixers, magnetic mixers, rotor stator mixers, homogenizers, vortex mixers, gas injection mixers, and any other mixer that can work with a combined liquid and particulate medium may be used in this technology. The higher the shear strength, the shorter is the time that may be used in effecting the desired shear results. The shear results may be measured in the weight percentage of original seed solids that passes through a predefined woven wire mesh screen (e.g., the 1.2 mm (U.S. sieve type 16) or 1.5 mm mesh screen (US sieve type 14) mesh screen discussed herein) to define a range of some of the preferred products of the present technology. Both smaller mesh size screen (e.g., 0.8, 1.0, etc.) may be used as may larger screens (e.g., 1.4, 1.5 mm. 1.8 mm, 2.0) although the larger screens will tends to provide slightly thicker products.

A general description of the process may be described as follows:

A method of providing a milled whole seed product has steps that may include
a. providing a whole seed having natural oil therein;
b. adding the whole seed to an aqueous carrier;
c. physically milling the whole seed in the aqueous carrier by shearing:
d. continuing shearing to form a non-mucilaginous aqueous suspension, so that the non-mucilaginous materials can pass 90% by weight of seeds solids through a 1.2 micron screen; and
e. collecting the non-mucilaginous aqueous suspension as a milled whole seed product.
   The collecting may be done en masse (collecting the entire suspension/dispersion or by filtering out the coarser particles through filtration to collect a suspension/dispersion of finer particles. If there is sufficient shearing in the process, or if some proportion of coarser particles can be tolerated, the sheared whole seed in aqueous carrier need not be filtered. The suspension/dispersion may be used as is, or dried, as further described herein, to form a rehydratable free-flowing powder which can form non-mucilaginous suspensions/dispersions upon rehydration.
   An alternative description as a method may include steps such as providing a milled whole seed product by:
a. providing a whole seed having natural oil therein;
b. adding the whole seed to an aqueous carrier;
c. physically milling the whole seed in the aqueous carrier;
d. continuing shearing to form a milled whole seed product until at least 40% by weight of seed solids can pass through a square mesh screen having 1.5 mm screen hole dimensions.
   In this second method, for example, the at least 40% by weight of seed solids may be collected and separated as a suspension or dispersion in the aqueous carrier. The collected non-mucilaginous suspension of milled whole seed solids in aqueous carrier may be dried to form a free-flowing powder. The free-flowing powder may be rehydrated with a second aqueous medium to form a non-mucilaginous suspension or dispersion. The whole seed of the milled whole seed product is preferably selected from the group consisting of Chia and Flax.
   The method may have shearing (a result of milling) performed at a sufficient rate and time so that at least 75% or 80% or 90% by weight of sheared whole seed solids as a suspension or dispersion in the aqueous carrier can pass through a 1.2 mm opening screen. The at least 75% by weight of sheared whole seed solids may be collected and separated as a suspension or dispersion in the aqueous carrier. The 40%, 75%, 80% or 90% solids in the suspension or dispersion in the aqueous carrier preferably can pass through a 1.5 mm opening screen by gravity filtering at 1 atmosphere of pressure. That is, high pressure is not needed to force the liquid and solids through the screen, although 1.1 atmosphere to 1.5 atmospheres of pressure, for example, can speed up the passage of the material through the screen.

Another aspect of the present invention and technology is the resulting free flowing particles of milled whole seed product which, when hydrated into an aqueous carrier, form a non-mucilaginous suspension or dispersion. For example, a mixture of 25% by weight free-flowing powder of the present technology and 75% by weight deionized water can be hand-stirred (or mechanically stirred at an equivalent, low shear rate similar to hand stirring) for a minute to form the non-mucilaginous dispersion or suspension. The second aqueous carrier may comprise soup, yogurt, flavored liquids, nutrition drinks, health drinks, gravy, sauces and the like.

The method preferably would have the collected seed solids in aqueous carrier dried to form a free-flowing powder. The free-flowing powder could then be rehydrated with a second aqueous medium to form a non-mucilaginous suspension or dispersion, usually having properties that can be readily tailored without any mucilaginous coagulation. The material can be dispersed into many food products (such as oatmeal, cream grain cereals, puddings, soups, yogurts, ice creams and soft foods to add consistency, mouth feel and moisture retention as well as the health benefits of the natural oils.

The method may be performed where shearing is performed at a sufficient rate and time so that at least 75% by weight of solids as a suspension or dispersion in the aqueous carrier pass through a 1.5 mm opening screen or so that at least 80% by weight of solids as a suspension or dispersion in the aqueous carrier pass through a 1.2 mm opening screen or so that at least 90% by weight of solids as a suspension or dispersion in the aqueous carrier pass through a 1.2 mm opening screen. Such filtering may be done by gravity or with assisted pressure on the solution/dispersion to speed the filtering of the sheared whole seed in aqueous carrier.

In another alternative method there would be steps such as
a) A whole seed material (preferably a whole seed comprising at least 0.01% by weight omega-3 oil) such, as Chia or flax is added to an aqueous medium to form the pretreated seed material.
b) The pretreated seed material is optionally soaked in the aqueous medium before shearing is begun or shearing is immediately begun.
c) Shearing is done at sufficient intensity (e.g., >3000 r.p.m., preferably 3,000-12,000 r.p.m., more preferably 5,000 to 11,000 r.p.m. and more preferably from 7,000 to 10,000 r.p.m. for sufficient time (this is shear related, and may be for at least 20 seconds at the highest shear levels to 15 minutes or fewer at lower shear levels, with excessive shear not being an issue) such that at least 20%, preferably at least 50%, more preferably at least 80% and most preferably at least 90%, and even at least 95% or more (all percentages are weight percent unless otherwise stated) solids milled from the whole seed pass through the 1.2 mm size screen to form a suspension/dispersion of particles in the aqueous medium.
d) Once the suspension/dispersion has been formed, it is dried (e.g., spray dried, mild thermal drying, infrared lamps over a conveyor belt, air dried, roller milled dried, mild oven drying) to provide distinct particles in a free flowing form. Physical stirring to separate any mildly agglomerated particles may be used. This type of process forms the free-flowing particles.
   After the free flowing particles, or powder has been formed, this product may be stored and later rehydrated to reconstitute a liquid or paste composition. If the viscosity and other flow properties of the suspension/dispersion are measured before drying into the free-flowing powder, the powder may be reconstituted by addition of water to essentially an identical state and properties as the pre-dried suspension/dispersion.

The pre-dried suspension/dispersion and the reconstituted material can be made non-mucilaginous, or non-clumping and non-thickened (low to moderate viscosity and self-adherence). This tends to be surprising as whole seed and lightly ground seed of the same seed variety (e.g., Chia) forms a highly mucilaginous medium, which can make its use difficult and therefore reduce the value of the product. The highly dispersible and combinable free-flowing powders of the present technology, which are not mucilaginous, are therefore highly desirable for addition into food (such as soups and beverages).

The following non-limiting examples will further assist in an appreciation and enablement of technology within the scope of the present invention.

### EXAMPLES

### Example 1

### Outside the Invention

400 g of whole Chia Seeds were added to 1 L deionized (DI) water at room temperature (20° C.) and allowed to rest for thirty minutes. The mucilaginous liquid poured off of a spoon as one cohesive lump and 0 grams of solids passed through a 1.2 mm square hole mesh screen. Material such as this being 0% yield is not suitable from a viscosity standpoint to be spray dried to a dry power and rehydrated.

### Example 2

### Invention

400 g of whole Chia Seeds were added to 1 L deionized (DI) water at room temperature (20° C.) and was added to a Silverson L4RY laboratory rotor stator mixer using a standard Silverson General Purpose Disintegrating Head which has Six large circular holes in the stator and then sheared for 30 seconds at 8000 r.p.m. The processed medium poured off a spoon as a thin lump, with 105 grams (25.4% by weight) of solids passing through a 1.2 mm square whole mesh screen and was collected as solids in a liquid carrier. The material passing through the screen is of a suitable viscosity for successful spray drying to a sub 100 micron powder.

### Example 3

### Invention

400 g of whole Chia Seeds were added to 1 L deionized (DI) water at room temperature (20° C.) and was added to a Silverson L4RY laboratory rotor stator mixer using the Silverson General Purpose Disintegrating Head and then sheared for 3 minutes at 8000 r.p.m. The resulting aqueous material poured off a spoon as a stream with drips. 192.3 grams of solids (48.1%) passed through a 1.2 mm square whole mesh screen and was collected as solids in a liquid carrier. The material passing through the screen is of a suitable viscosity for successful spray drying to a sub 100 micron powder.

### Example 4

### Invention

400 g of whole Chia Seeds were added to 1 L deionized (DI) water at room temperature (20° C.) and added to a Silverson L4RY laboratory mixer using the Silverson General Purpose Disintegrating Head and then sheared for 3 minutes at 8000 r.p.m. This material was then sheared using a Silverson L4RY laboratory rotor stator mixer with a Silverson Square Hole High Shear Screen™ for 1 minute at 9000 r.p.m. The completed batch was passed through a 1.2 mm whole square mesh screen. The resulting suspension/dispersion poured off of a spoon as a steady stream. 388.3 grams solids (97.1% by weight) passed through the two screens and was collected as solids in a liquid carrier. The material passing through the screen is of a suitable viscosity for successful spray drying to a sub 100 micron powder.

### Example 5

### Invention

400 g of whole Chia Seeds were added to 1 L deionized (DI) water at room temperature (20° C.) and added to a Silverson L4RY laboratory mixer using the Silverson General Purpose Disintegrating Head and then sheared for 3 minutes at 9500 r.p.m. This material was then sheared using a Silverson L4RY laboratory rotor stator mixer with a Silverson Square Hole High Shear Screen™ for 5 minutes at 9500 r.p.m. The completed batch was passed through a 1.2 mm whole square mesh screen. The resulting suspension/dispersion poured off of a spoon as a lower viscosity steady stream than materials in Example 4. 394.3 grams solids (98.6%) passed through the two screens and was collected as solids in a liquid carrier. The material passing through the screen is of a suitable viscosity for successful spray drying to a sub 100 micron powder.

Powders made with examples 2-5 are all suitable for spray drying to a fine powder at sub 100 micron particle sizes. Dried powders can be further dried as required by air or infrared dried on a conveyor belt if necessary.

Such powders easily rehydrated when added at 25 wt % or less to 1 liter of deionized water. For example powder materials from Example 4 was added at 7 wt % to deionized water and resulted in a dispersion/suspension nearly identical in viscosity of its predried suspension. In addition, the rehydrated powders display a non-mucilaginous consistency of benefit in aqueous liquids such as soups and gravy.

Exactly how much of conventional Chia's fiber is insoluble and soluble is hard to pin down. But about three-fourths is insoluble and one-fourth soluble. Still, Chia's soluble fiber has a much higher viscosity than other dietary fibers such as beta-glucan and guar. This means that it has significantly increased intestinal transit time, delayed gastric emptying, and a slower rate of glucose absorption. Richardo Ayerza Jr., Dr. Coates wrote the definitive book on the subject, Chia: Rediscovering a Forgotten Crop of the Aztecs (The University of Arizona Press, 2005), which is incorporated herein by reference in its entirety.

Traditional recipes for (found in the book by James F. Sheer, The Magic of Chia (Berkeley, Calif., Frog Ltd., 2001), which are outside the scope of the present invention, essentially all call for soaking the Chia in a glass of water to form a gel, without high shearing of the seeds into a fine suspension/dispersion and without any drying and rehydrating of the fine suspension/dispersion.

Mucilage is a thick, gluey substance produced by most plants and some microorganisms. It is a polar glycoprotein and an exopolysaccharide. It occurs in various parts of nearly all classes of plant, usually in relatively small percentages, and is frequently associated with other substances, such as tannins and alkaloids. Mucilage in plants is thought to aid in water storage and seed germination, and to act as a membrane thickener and food reserve. Among the richest sources are cacti (and other succulents) and flaxseeds. Mucilage has a unique purpose in some carnivorous plants. For example, the plant genera Drosera (Sundews), Piguicula, and others have leaves studded with mucilage-secreting glands, and use a “flypaper trap” to capture insects.

Exopolysaccharides are the most stabilising factor for microaggregates and are widely distributed in soils. Therefore exopolysaccharide-producing “soil algae” play a vital role in the ecologyof the world's soils. The substance covers the outside of, for example, unicellular or filamentous green algaeand cyanobacteria. Amongst the green algae especially, the group Volvocalesare known to produce exopolysaccharides in a certain part of their life cycle.

Chia seed produces a thick mucilage in water, absorbing up to 30 times its weight in water. This soluble fiber cleans the intestines by binging and transporting debris from the intestinal walls so that it can be eliminated efficiently and regularly. A daily dose of Chia seed provides an excellent fiber source and most people notice a different in less than a week.

Although specific examples of seeds, amounts, proportions, temperatures and conditions have been provided, those specifics are merely examples within the generic concepts of the present technology. One skilled in the art appreciates and foresees variations in those parameters within the scope of practice of the present technology.

What is claimed:

1. A method of providing a milled whole seed product comprising
a) providing a whole seed having natural oil therein;
b) adding the whole seed to an aqueous carrier;
c) physically milling the whole seed in the aqueous carrier:
d) continuing shearing to form a non-mucilaginous aqueous suspension, such non-mucilaginous materials can pass 90% by weight of seeds solids through a 1.2 micron screen; and
e) collecting the non-mucilaginous aqueous suspension as a milled whole seed product.

2. A method of providing a milled whole seed product comprising:
a. providing a whole seed having natural oil therein;
b. adding the whole seed to an aqueous carrier;
c. physically milling the whole seed in the aqueous carrier;
d. continuing shearing to form a milled whole seed product until at least 40% by weight of seed solids can pass through a square mesh screen having 1.5 mm screen hole dimensions.

3. The method of claim 2 wherein the at least 40% by weight of seed solids is collected and separated as a suspension or dispersion in the aqueous carrier.

4. The method of claim 1 wherein the collected non-mucilaginous suspension of milled whole seed solids in aqueous carrier is dried to form a free-flowing powder.

5. The method of claim 4 wherein the free-flowing powder is rehydrated with a second aqueous medium to form a non-mucilaginous suspension or dispersion.

6. The method of claim 2 wherein the collected and separated suspension or dispersion in the aqueous carrier is dried to form a free-flowing powder.

7. The method of claim 6 wherein the free-flowing powder is rehydrated with a second aqueous medium to form a non-mucilaginous suspension or dispersion.

8. The method of claim 1 wherein the seed of the milled whole seed product is selected from the group consisting of Chia and Flax.

9. The method of claim 2 wherein the seed of the whole seed milled product forming the suspension or dispersion is selected from the group consisting of Chia and Flax.

10. The method of claim 3 wherein the seed forming the milled whole seed product comprises a seeds selected from the group consisting of Chia and Flax.

11. The method of claim 5 wherein the seed of the whole seed milled product forming the suspension or dispersion is selected from the group consisting of Chia and Flax.

12. The method of claim 2 wherein shearing is performed at a sufficient rate and time so that at least 75% by weight of sheared whole seed solids as a suspension or dispersion in the aqueous carrier can pass through a 1.2 mm opening screen.

13. The method of claim 12 wherein the at least 75% by weight of sheared whole seed solids is collected and separated as a suspension or dispersion in the aqueous carrier.

14. The method of claim 2 wherein shearing is performed at a sufficient rate and time so that at least 80% by weight of solids as a suspension or dispersion in the aqueous carrier can pass through a 1.2 mm opening screen by gravity filtering at 1 atmosphere of pressure.

15. The method of claim 2 wherein shearing is performed at a sufficient rate and time so that at least 90% by weight of solids as a suspension or dispersion in the aqueous carrier can pass through a 1.2 mm opening screen by gravity filtering at 1 atmosphere of pressure.

16. Free flowing particles of milled whole seed product which, when hydrated into an aqueous carrier consisting of 75% by weight deionized water and 25% by weight of the free-flowing particles and stirred for 1 minute, form a non-mucilaginous suspension or dispersion.

17. The free flowing particle of claim 16, where the milled whole seed product comprises sheared Chia seed.

18. The free lowing particle of claim 16, where the milled while seed product comprises a combination of sheared Chia and Flax seed.

19. The free flowing particle of claim 16, where the aqueous carrier comprises a potable beverage.

20. The free flowing particle of claim 16, where the aqueous carrier comprises soup.
